(19) United States
(12) Patent Application Publication
(10) Pub. No.: US 2009/0309853 A1
(43) Pub. Date: Dec. 17, 2009

(54) ELECTRONIC WHITEBOARD SYSTEM AND ASSEMBLY WITH OPTICAL DETECTION ELEMENTS

(75) Inventors: Peter W. Hildebrandt, Duluth, GA (US); James Watson, Duluth, GA (US); Neal Hofmann, Atlanta, GA (US); Brent Anderson, Portland, OR (US); Steve Takayama, Palo Alto, CA (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: POLYVISION CORPORATION, Suwannee, GA (US)

(21) Appl. No.: 12/138,689

(22) Filed: Jun. 13, 2008

(51) Int. Cl. G06F 3/042

(52) U.S. Cl. 345/175

(57) ABSTRACT

An electronic whiteboard system and assembly with optical detection elements is disclosed. The electronic whiteboard system includes a writing/display surface and a retroreflective perimeter surrounding the edge of the surface. A user can mark upon the surface or interact with an image displayed on the surface using an input device. The perimeter can reflect light beams emitted from optical detection elements located at the corners of the surface to identify the position of the input device relative to the writing surface and/or projected image. The electronic whiteboard assembly includes one or more electronic whiteboard systems coupled together with a connector element having two retroreflective surfaces.

### BACKGROUND

Embodiments of the present invention relate in general to an electronic whiteboard with optical detection elements. In particular, exemplary embodiments relate to an electronic whiteboard assembly with a plurality of optical detection elements for determining the coordinates of an input device relative to the display surface.

Whiteboards are a well known medium for facilitating the exchange of information by providing a convenient surface upon which notes, drawings, charts, or other notations may be made. As with the traditional chalkboard, whiteboards allow notations to be made in multiple colors and to then be erased. Whiteboards offer several advantages over chalkboards including a clean white surface that provides for greater contrast over the traditional green or black background of chalkboards. In addition, writing on a whiteboard is easier for many than on the traditional chalkboard. For example, the smooth writing surface of the whiteboard allows easy use of the erasable felt tip markers used on whiteboards, whereas the chalkboard surface provides a somewhat scratchy surface to hold the chalk used for writing on such surfaces. In addition, many users prefer a whiteboard to a chalkboard simply because the marker may be gripped easier than chalk and does not mark the user's hand when gripped.

Recently, electronic whiteboards have been developed to allow the user's writings and notations entered upon the display surface of the whiteboard to be electronically captured and transmitted to a computer for storage, display, and manipulation. Such electronic whiteboards allow the images and notations made upon the whiteboard to be saved in the computer, to be displayed, printed, transmitted or manipulated.

Various methods and devices for detecting the position of an input device relative to the display surface of an electronic whiteboard have been previously developed. For example, position or pressure sensing input devices using tactile sensors have been employed in conventional electronic whiteboard systems. These conventional approaches, however, often are complex, difficult, or expensive to manufacture, and/or have limited performance, especially for large area input device applications.

While conventional electronic whiteboard designs increase the versatility and usability of the traditional whiteboard, a need continues to exist for an electronic whiteboard with improved means for detecting input on the display surface from a user and associating the input with an image displayed on the whiteboard and a larger functional display area. The embodiments described below are directed to these and other improvements over conventional systems.

### SUMMARY

Embodiments of the present invention are directed to an electronic whiteboard system and assembly with optical detection elements. The electronic whiteboard system includes a writing/display surface and a retroreflective perimeter surrounding the edge of the surface. A user can mark upon the surface or interact with an image displayed on the surface using an input device. The perimeter can reflect light beams emitted from optical detection elements located at the corners of the surface to identify the position of the input device relative to the writing surface and/or projected image. The electronic whiteboard assembly includes one or more electronic whiteboard systems coupled together with a connector element. An electronic whiteboard assembly implementing the connector element can provide a larger writing/display surface than a single electronic whiteboard system.

In an exemplary embodiment, the electronic whiteboard system can comprise a writing surface, a first optical detection element coupled to the writing surface, a second optical detection element coupled to the writing surface, and a divider element disposed proximate the writing surface between the first and second optical detectors. The optical detection elements can be coupled to the corners of the writing surface and detect an input device by measuring decreases in the intensity of light emitted from the elements and reflected back by a retroreflective perimeter surrounding the writing surface.

In an exemplary embodiment, the electronic whiteboard assembly comprises a first writing surface having a first side, a second side, a third side, and a fourth side, a second writing surface having a first side, a second side, a third side, and a fourth side, a first perimeter disposed along the first, second, and third sides of the first writing surface, a second perimeter disposed along the first, second, and third sides of the of the second writing surface, and a connector element engaging the fourth side of the first writing surface and the fourth side of the second writing surface to connect the first and second writing surfaces. The assembly can further comprise an optical detection unit disposed at least two of the corners of each the writing surfaces. The perimeters and connector element are retroreflective to reflect light beams emitted from the optical detection unit back toward the units along their original paths. The decrease in the intensity of reflected light can be used to detect an input device. Markings made by the input device on the first surface and the second surface can be combined to form a single continuous marking.

In an exemplary embodiment, the electronic whiteboard connector for coupling a first and a second electronic whiteboard can comprise a body adapted to be disposed between the edges of the first and second whiteboards, a first engagement portion for engaging an edge of the first electronic whiteboard, a second engagement portion for engaging an edge of the second electronic whiteboard, and a reflective portion extending from the surface of the electronic whiteboards. The engagement portions can be dovetails adapted to be receiver by the edges of the electronic whiteboards. The connector can be frictionally secured to the whiteboards or affixed using a fastener, adhesive, or another attachment means.

These and other features as well as advantages, which characterize various exemplary embodiments of the present invention, will be apparent from a reading of the following detailed description and a review of the associated drawings.

### BRIEF DESCRIPTION OF THE DRAWINGS

FIG. 1 illustrates an exemplary embodiment of an electronic whiteboard system.

FIG. 2 illustrates an exemplary embodiment of an electronic whiteboard system for use with a projector.

FIG. 3 illustrates an exemplary embodiment of an electronic whiteboard assembly.

FIG. 4 illustrates an exemplary embodiment of a fastening device for connecting two electronic whiteboard systems.

FIG. 5 illustrates an electronic whiteboard assembly without a middle reflective perimeter.

FIG. 6 illustrates an exemplary embodiment of electronic whiteboard assembly.

FIG. 7 illustrates a cross-section of an exemplary embodiment of a sliding dovetail joint configuration of a connector element for joining two adjacent electronic whiteboards.

FIG. 8 illustrates a cross-section of an exemplary embodiment of an “I-beam” joint configuration of a connector element for joining two adjacent electronic whiteboards.

FIG. 9 illustrates a cross-section of an exemplary embodiments of a “T-shape” connector element.

### DETAILED DESCRIPTION

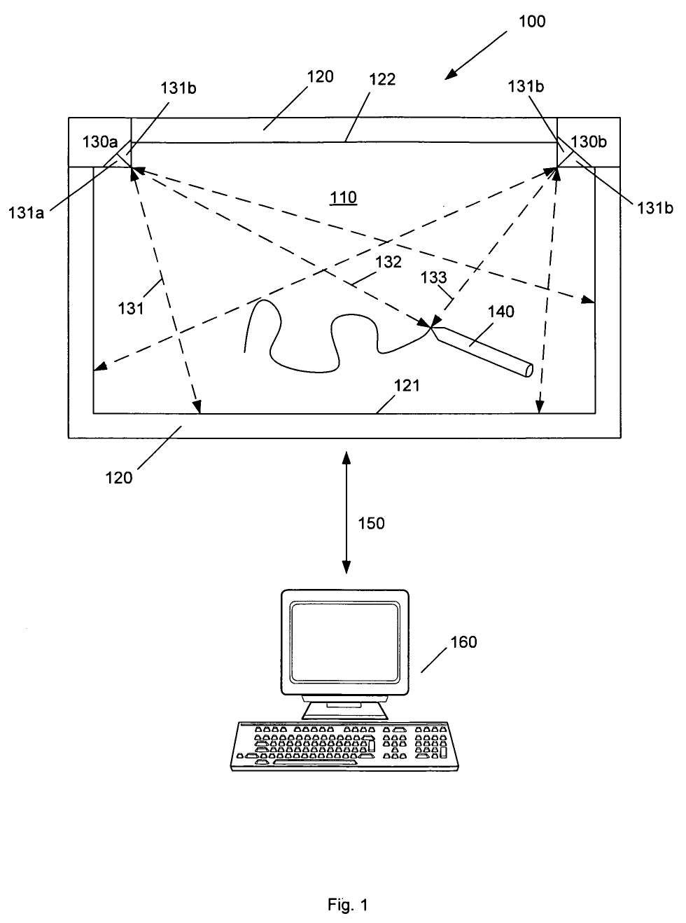

Referring now in detail to the drawing figures, wherein like reference numerals represent like parts throughout the several views, FIG. 1 illustrates an exemplary embodiment of an electronic whiteboard system 100. The electronic whiteboard system 100 can comprise a display surface 110, a perimeter 120, and one or more optical detection elements. In the exemplary embodiment illustrated, the electronic whiteboard system 100 comprises a first optical detection element 130a and a second optical detection element 130b. The electronic whiteboard system 100 can be vertically mounted on a surface such as a wall.

In an exemplary embodiment, the display surface 110 can be substantially similar to the writing surface of a conventional dry erase whiteboard. A user can provide an input onto the display surface 110 using an input device 140. The input device can be a felt tip-marker, a pointer, a stylus, the user's finger, an eraser, or other suitable implements. In an exemplary embodiment, the input device 140 can be a dry erase marker.

As the user provides an input or marks upon the display surface 110 using the input device 140, the first and second optical detection element 130a and 130b can detect the position of the input device 140 relative to the display surface 140. The various positions of the input device 140 can be used to determine the input provided by the user.

Optical detection element 130a can comprise an emitter 131a and a receiver 131b. Similarly, optical detection element 130b can comprise an emitter 132a and a receiver 132b. Emitters 131a and 132a can emit electromagnetic radiation such as an infrared light beam. In an exemplary embodiment, the emitters 131a and 132a can be an infrared light emitting diode (LED). Correspondingly, receivers 131b and 132b preferably can detect an infrared light beam. In other embodiments, the emitters 131a and 131b can be ultrasonic or another suitable form of energy and the receivers 131b and 132b preferably are capable of detecting said energy. In an exemplary embodiment, the optical receiver elements 131b and 132b can be coupled charge device (CCD) cameras.

The optical detection elements 130a and 130b can be disposed on or coupled to the front or back of the perimeter 120 or the display surface 110. In other embodiments, the optical detection elements 130a and 130b can have a mounting assembly enabling attachment to a surface other the display surface 110 or the perimeter 120, such as a wall. In one embodiment, optical detection elements 130a and 130b can be coupled or disposed at the upper corners. In other contemplated embodiments, the optical detection elements can be coupled to the lower or side corners.

The perimeter 120 can extend around edges of the display surface 110. The perimeter 120 can extend above the plane of the display surface 110 to define an interior perimeter surface 121 normal to the plane of the display surface 110. The interior perimeter surface 121 can have retroreflective characteristics. In one embodiment, the interior perimeter surface 121 can have a retroreflector along its length. In other embodiments, the retroreflector not be disposed along the entire interior perimeter surface 121. For example, the top side 122 of the interior perimeter surface 121 does not need to be retroreflective for the system to operate.

The interior perimeter surface 121 can reflect an infrared light beam emitted by the emitters 131a and 131b of optical detection elements 130a and 130b back along a vector that is parallel to but opposite in direction from the angle of incidence of the beam. Consequently, a beam 131 emitted from first optical detection element 130a can be reflected by the interior perimeter surface 121 directly back to the optical detection element 130a and detected by a receiver. Retroreflective materials may be capable of reflecting light beams back within a certain angle of incidence. The portions interior perimeter surface 121 that are at high angle of incidence relative emitters 131a and 131b of optical detection elements 130a and 130b can be adapted to facilitate reflection. For example, said portions of the perimeter surface 121 could comprise wide angle retroreflective material or can be curved, angled, corrugated, or otherwise altered to increase reflection.

The optical detection elements 130a and 130b each can have a field of view that includes a detection area defined by the bottom horizontal portion of the interior perimeter surface 121 and the majority of the vertical portion of the interior perimeter surface 121 opposite said element. In this manner, the field of view of the first optical detection element 130a substantially overlaps with the field of view of the second optical detection element 130b. The detection area is preferably two dimensional, which enables detecting presence of an object in contact with or in proximity to the display surface 110. This also reduces the flatness requirement of the surface. The pixel dimension of the optical detection elements 130a and 130b can be selected to achieve the desired field of view.

The optical detection elements 130a and 130b both emit a plurality of infrared beams onto their respective detection areas. The emitted beams are reflected by the interior perimeter surface 121 back to the receivers of the optical detection elements 130a and 130b. The optical detection elements 130a and 130b can simultaneously emit a plurality of beams onto their entire detection areas. Alternatively, the optical detection elements 130a and 130b can rapidly scan across their respective detection areas, illuminating a portion of the detection area at one time.

The optical detection elements 130a and 130b can detect the input device 140 in contact with or in proximity to the display surface 140. The surface of input device 140 is not reflective or substantially less reflective than the interior perimeter surface 121. Consequently, an input device 140 effectively blocks certain beams emitted from optical detection element 130a and 130b from being reflected back to the optical detection elements 130a and 130b by the interior perimeter surface 121. This absence of reflected beams can be detected by the receivers of the optical detection elements 130a and 130b as a point of lower intensity in the detection area. For example, in FIG. 1, input device 140 blocks beams 132 and 133. Consequently, these beams will only partially be reflected back to the optical detection elements 130a and 130b and a reduction in intensity will be detected by the receivers in comparison to the beams reflected by the interior perimeter surface 121.

The electronic whiteboard system 100 can be in communication with a computation device 160 via a communication link 150. The computation device 160 can be a personal computer (PC), laptop, personal digital assistant, tablet PC, room booking system, Smartphone, or another suitable electronic device capable of executing an operating system. The communication link 150 can be a wireless link such as infrared, radio-frequency, or another suitable wireless communication protocol. Alternatively, the communication link 150 can be a hardwire link such as USB, USB 2.0, firewire, serial cable, coaxial cable, or another suitable electronic communication cable. In further embodiments, the electronic whiteboard system 100 and computation device 160 can be part of a local area network (LAN) or connected through a network, such as a LAN. In alternative embodiments, the computation device 160 can be integrated into the electronic whiteboard system 100.

The computation device 160 can comprise software and data relating to the electronic whiteboard system 100 that enables it to record markings made by a user on the display surface 110. The computation device 160 can have data relating to a baseline reading of light beams detected by the receivers of the optical detection elements 130a and 130a when an input device is not in contact or proximity to the display surface 110. The computation device can receive actual light beam detection readings from the electronic whiteboard system 100 and compare these readings to the base line readings. A decrease in the intensity of the light readings can indicate the presence of an object, such an input device. Comparing the readings from the both the first and second optical detection elements 130a and 130b, the computation device 160 can triangulate the position of the input device 140 relative to the display surface 140. Comparing multiple successive readings, the computation device 160 can determine a marking, such as a letter or scribble, made upon the display surface. It can also record multiple simultaneous touch points to allow gestural interfaces or allow two people to write on the board simultaneously.

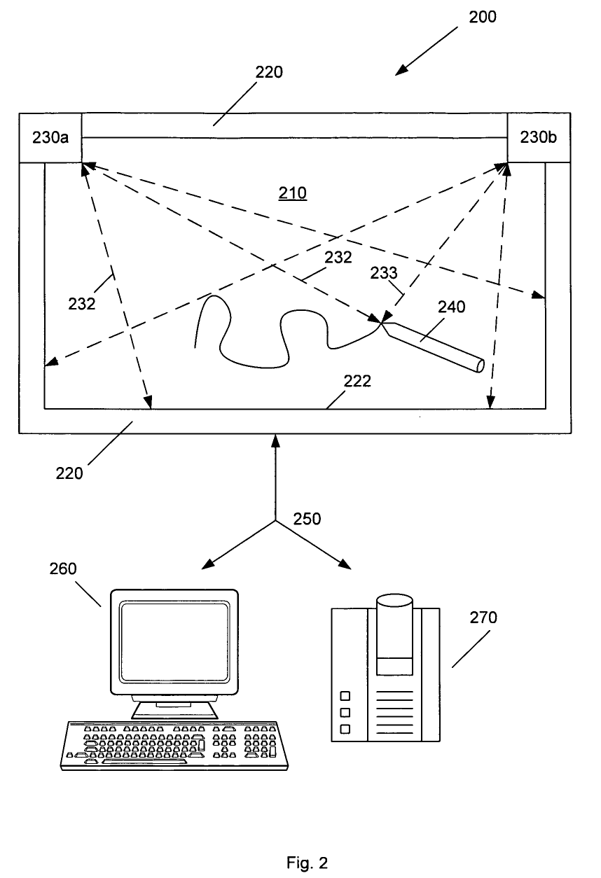

FIG. 2 illustrates an embodiment of an electronic whiteboard system 200 for use with a projector 270. The electronic whiteboard system 200, computation device 260, and projector 270 can be in communication with each other via a communication link 250. The communication link 250 can be substantially similar to the communication link described above. The communication link 250 can be a single link between the system 200, projector 270 and computation device 260. In other embodiments, the communication link 250 can be two separate links, a first link between the system 200 and the computation device 260 and a second link between the computation device 260 and the projector 270. In an exemplary embodiment, the projector 270 can manifest a screen or desktop image, for example, a graphical user interface (GUI), from the computation device 260 onto the display surface 210. The electronic whiteboard system 200 can be calibrated to determine its position relative to the display surface. Further, the computation device 260 can correlate the position of the projected image relative the display surface 210 with the position of an input device 240. This can enable a user to interact with the projected image through the electronic whiteboard system 200 in a variety of ways. For example, a user can manipulate an image of a projected desktop using an input device 240 that functions as a mouse cursor. The user can open and close programs by pointing and “clicking” on the display surface using the input device 240 as if seated at the computation device 260.

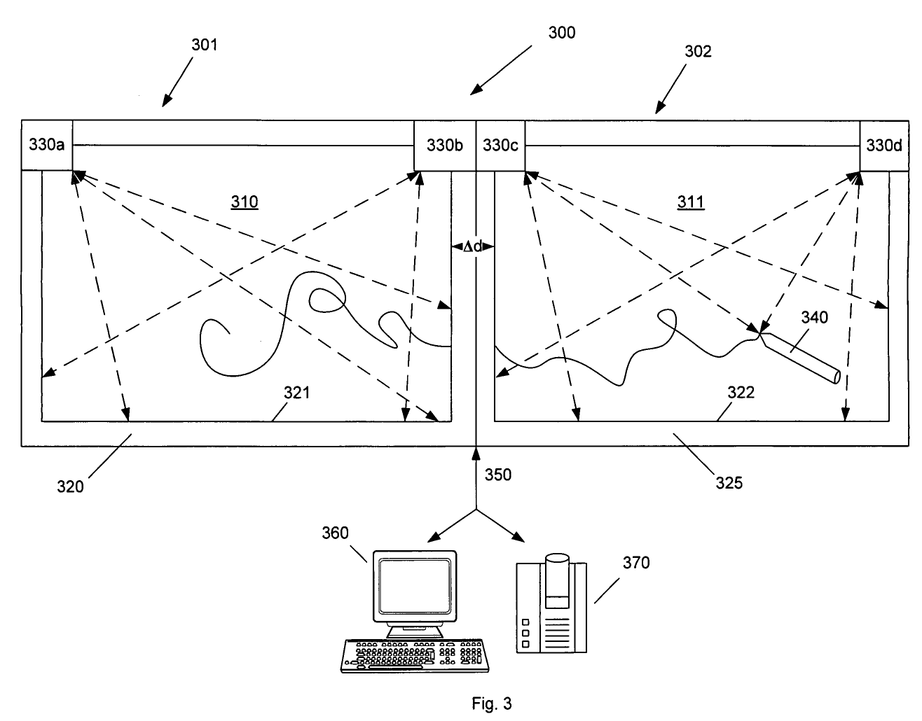

FIG. 3 illustrates an exemplary embodiment of an electronic whiteboard assembly 300. The electronic whiteboard assembly 300 provides a larger display and writing surface by combining one or more of the electronic whiteboard systems described above. In an exemplary embodiment, the electronic whiteboard assembly 300 comprises a first electronic whiteboard system 301 and a second electronic whiteboard system 302, the first and second electronic whiteboard systems 301 and 302 can be substantially similar to the electronic whiteboard systems described in the embodiments above.

The first electronic whiteboard system 301 of the electronic whiteboard assembly 300 can comprise a first display surface 310 surrounded by a first perimeter 320 defining a first interior perimeter surface 321. The electronic whiteboard assembly can further comprises first and second optical detection elements 330a and 330b for detecting the presence of an object in contact with or in the vicinity of the first display surface 310, substantially as described above. The first and second optical detection elements 330a and 330b can be disposed at the top corners of the first perimeter 320 and/or first display surface 310 and include at least one emitter device and receiver device.

The second electronic whiteboard system 302 of the electronic whiteboard assembly 300 can further comprise a second perimeter 325 surround a second display surface 311. The second perimeter 321 can define a second interior perimeter surface 322. The second electronic whiteboard system 302 can further comprise third and fourth optical detection elements 330c and 330d disposed at two corners of the system 302. The third and fourth optical detection elements 330c and 330d can detect the presence of an object in contact with or in proximity to the second display surface 311.

The electronic whiteboard assembly 300 can be in communication with a computation device 360 via a communication link 350 substantially similar to the communication links described in the embodiments above. That computation device 360 can receive data from the first and second electronic whiteboard systems 301 and 302 and determine a marking made by an input device 140 in substantially the same manner as described above. Additionally, the computation device can merge data received from the first and second electronic whiteboard systems 301 and 302 such that the first and second writing surfaces 310 and 311 are interpreted as a single larger writing surface. Marking made by a user starting on the first writing surface 310 continuing onto the second writing surface 311 can be interpreted and stored as a single marking rather than two separate markings.

The electronic whiteboard assembly 300 can also be in communication with a projector 370 in addition to the computation device 360. The projector 370 can manifest a single coherent image onto display surfaces 310 and 311. The image can be substantially similar to the image described above. For example, it can be a GUI. The projected image, however, can be substantially wider and/or taller than the image described above because the combined area of display surface 310 and 311 is larger than in the above embodiments. Multiple projectors can be used for extended desktops, or display of other related data.

The electronic whiteboard assembly 300 provides a larger effective total writing surface than the previously described embodiments. In the above embodiments of the electronic whiteboard assembly, two electronic whiteboards can be combined physically and functionally side by side. In other contemplated embodiments, more than two electronic whiteboard systems can be combined. In further contemplated embodiments, electronic whiteboard systems can be combined atop one another. In other embodiments, the systems can be combined both side by side and above each other. For example, an electronic whiteboard assembly can comprise a first row comprising three whiteboards and a second row atop above the first comprising an additional three whiteboards.

Using separate electronic whiteboards to construct a larger display surface is preferable for manufacturing, shipping, and installation purposes. In accordance with various embodiments, electronic whiteboard systems can be connected in a variety of ways. The electronic whiteboard systems can be permanently or releaseably connected using various suitable joints and fasteners. The boards can also be connected using adhesives. In other contemplated embodiments, the boards can be disposed proximate one another, but are not physically connected.

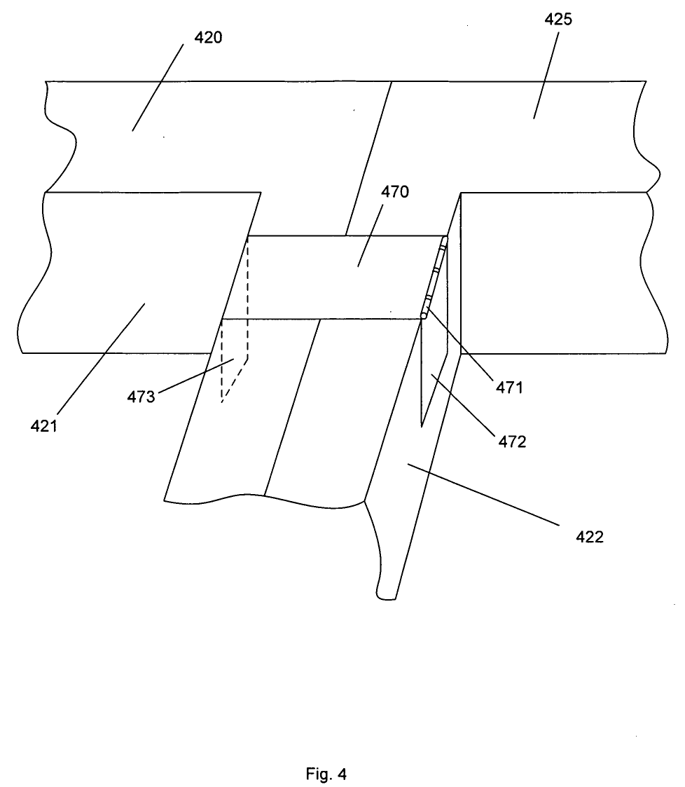

FIG. 4 illustrates an exemplary embodiment of a fastening device 470 for connecting two electronic whiteboard systems. The fastening device 470 is preferably u-shaped having a first side fixed normal to the base and a second side hingedly fixed to the base. The hinge 471 of the fastening device 470 can be spring loaded. The fastening device 470 can be disposed atop the first perimeter 420 and the second perimeter 425. The sides 472 and 473 of the fastening device 470 can engage the first interior perimeter surface 421 and the second interior perimeter surface 422. The exterior surfaces of the side of the fastening device 470 can be retroreflective similar to the interior perimeter surface so as not to interfere with the operation of the optical detection elements. The fastening device 470 can fix the whiteboards relative to one another by means of the tension in the springs or by an adhesive agents. Alternatively, the sides of the fastening device can comprise screw holes and the fastening element can attach to the whiteboard by means of screws. In such an embodiment, the hinge can remain to provide a hingedly connected whiteboard or be removed so that the boards can be fixed in relation to each other.

FIG. 3 illustrates that the thickness, indicated by the letter “d”, of the first perimeter 320 and the second perimeter 325, can interfere with the smooth writing/drawing transition from the first display surface 310 to the second surface 311. The perimeters 320 and 325 are not intended to be marked upon, and the optical detection elements 330a-d cannot sense contact of an input device 340 with the perimeters 320 and 325. This may be a minor inconvenience for many applications where the user can simply account for the break between the display surfaces 310 and 311, and adjust their markings accordingly. It can diminish the versatility of the electronic whiteboard assembly 300 for applications where a continuous larger marking is desired.

The problem may become more troublesome in applications of the electronic whiteboard assembly 300 incorporating the projector 370. The projector 370 can display a single continuous image spanning both display surfaces 310 and 311. Part of the image may be displayed on the perimeters 320 and 325. Consequently, a user will not be able to select or mark upon the portion of the image displayed upon the perimeters 320 and 325. For example, if a desktop is displayed, icons displayed on the perimeters 320 and 325 will not be accessible/selectable using the input device 340.

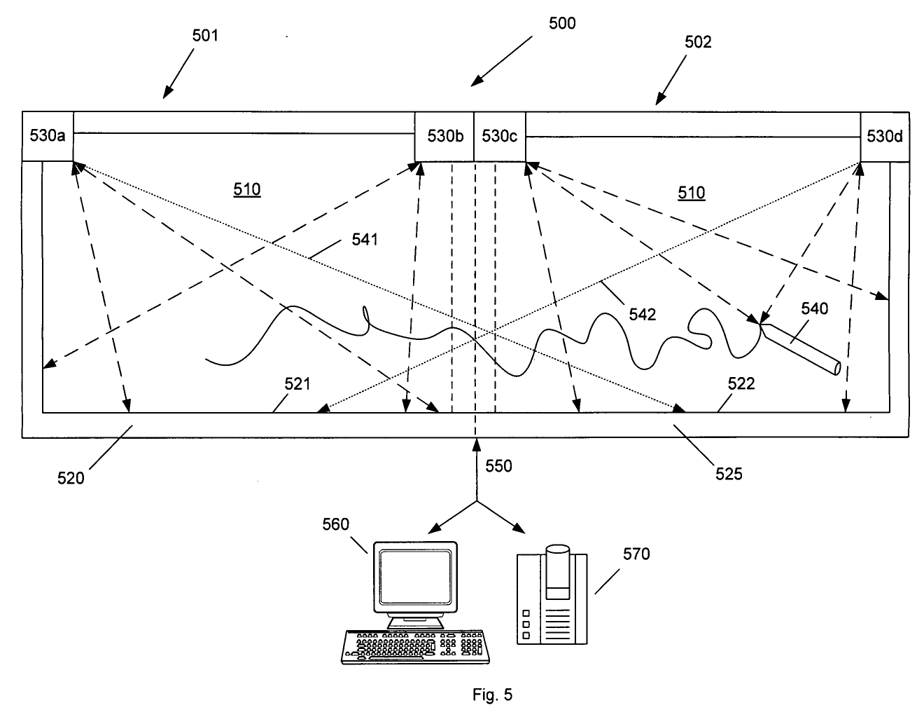

Removing the middle portions of the perimeters 320 and 325 can interfere with detecting objects due to the limited range of the optical detection elements 330a-d. FIG. 5 illustrates an electronic whiteboard assembly without a middle reflective perimeter. The electronic whiteboard assembly 500 is substantially similar to the electronic whiteboard assembly 300, however, the dashed vertical lines indicate that the portions of perimeters 520 and 525 have been removed, creating an undivided writing surface 510. In the embodiments of the electronic whiteboard assembly 300 described above, beam 541 would have been reflected by the vertical portion of the first interior perimeter surface 520.

As illustrated in FIG. 5, the beam 541 is instead reflected by the bottom horizontal surface of second interior perimeter surface 522. The distance the beam 541 travels is substantially increased, resulting in reduced intensity of the beam. Further, the receiver of the first optical detection element 530a may be unable to effectively resolve objects at such as distance or detect object at all. Additionally, the angle of incidence of beam 541 may be beyond the reflective range of the second interior perimeter surface 522, resulting in the beam not being reflected back. The same problem can exist for with respect to beam 542 and the fourth optical detection element 530d. Consequently, the optical detection elements 530a-d and computation device 560 may be unable to detect and/or accurately determine the position of input device 540.

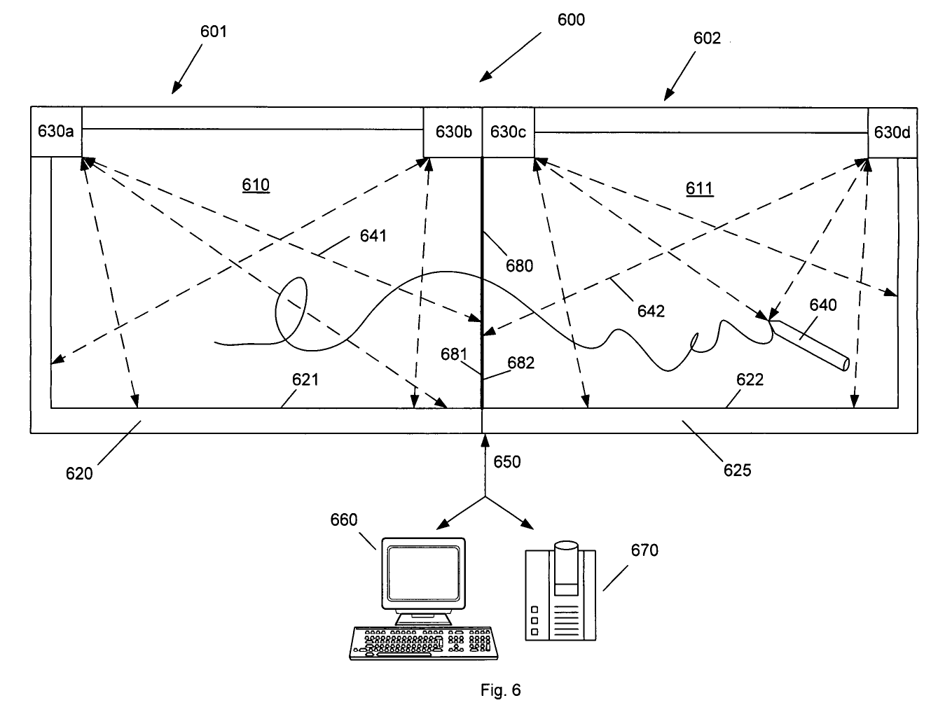

FIG. 6 illustrates an exemplary embodiment of electronic whiteboard assembly 600. The electronic whiteboard assembly can comprise a writing surface further comprising a first writing surface 610 and a second writing surface 611. The first and second writing surface 610 and 611 can be substantially similar to the display surfaces described in the embodiments above. The writing surfaces 610 and 611 can each have a first, second, third, and fourth side. The writing surface 610 and 611 are preferably rectangular in shape. In other embodiments, the writing surfaces 610 and 611 can be square or another suitable and desirable shape.

The electronic whiteboard assembly 600 can further comprise a first perimeter 620 and a second perimeter 625. The first perimeter 620 can substantially surround the first, second, and third sides of the first writing surface 610. Similarly, the second perimeter 625 can substantially surround the first, second, and third sides of the second writing surface 611. The first perimeter 620 can have a first retroreflective interior perimeter surface 621 normal to the first writing surface 610. Similarly, the second perimeter 625 can have a second retroreflective interior perimeter surface 622 normal to the second writing surface 611.

A connector element 680 can engage the fourth sides of the first and second writing surfaces 610 and 611 to connect the writing surfaces together. The first and second writing surfaces 610 and 611 are connected by the connector element 680 in a side by side manner to form a larger writing surface composed of the two adjacent writing surfaces 610 and 611. The connector element 680 can comprise a first retroreflective surface 681 normal and proximate to the first writing surface 610, and a second retroreflective surface 682 normal and proximate to the second writing surface. The first retroreflective interior perimeter surface 621 and the first retroreflective surface 681 of the connector element 680 can form a continuous retroreflective surface along the entire perimeter of the first writing surface 610. Similarly, the second retroreflective interior perimeter surface 622 and the second retroreflective surface 682 of the connector element 680 can form a continuous retroreflective surface along the entire perimeter of the second writing surface 611.

The electronic whiteboard assembly 600 can further comprise first and second optical detection units 630a and 630b coupled proximate separate corners of the first writing surface 610, and third and fourth optical detection units 630c and 630d coupled proximate separate corners of the second writing surface. The optical detection units 630a-d are preferably disposed in each of the upper corners of the first and second writing surfaces 610 and 611. Each of the optical detection units 630a-d can comprise a light emitting element and a light detecting element. The light emitting elements can emit an infrared light beam. The optical detection units 630a-d can function in a substantially similar manner to the optical detection elements described in the embodiments above.

The first interior perimeter retroreflective surface 621 and first retroreflective surface 681 can reflect light emitted by the light emitting elements of the first and second optical detection units 630a and 630b along a parallel path back to the light detecting elements of the units 630a and 630b. In particular, the first retroreflective surface 681 can reflect light beam 641 directly back to optical detection unit 630a. This overcomes the detection problems described above in relation to light beam 541 in FIG. 5. Similarly, the second interior perimeter retroreflective surface 622 and second retroreflective surface 682 can reflect light emitted by the light emitting elements of the third and fourth optical detection units 630c and 630d along a parallel path back to the light detecting elements of the units 630c and 630d.

The electronic whiteboard assembly 600 can be in communication with a computation device 660 and a projector 670 via a communication link 650. The communication link 650, computation device 660, and projector 670 can be substantially similar to corresponding components described in the above embodiments. The computation device 660 can receive data from the optical detection units 630a-d of the assembly 600 to determine a marking made by an input device 640 on either or both of the first and second writing surfaces 610 and 611. Data from the first and second writing surfaces 610 and 611 can be combined so that a marking spanning both surface 610 and 611 can be interpreted and recorded as a single marking. Similarly, an image can be manifest on the writing surfaces 610 and 611 through the projector 670 and manipulated and interfaced by a user with the input device 640.

The width of the connector element 680 is substantially less than the combined width Δd of the first and second perimeters 320 and 325 in FIG. 3. Consequently, transitioning from the first writing surface 610 to the second writing surface 611 is simplified, as is interfacing with an image projected on the first and second writing surfaces.

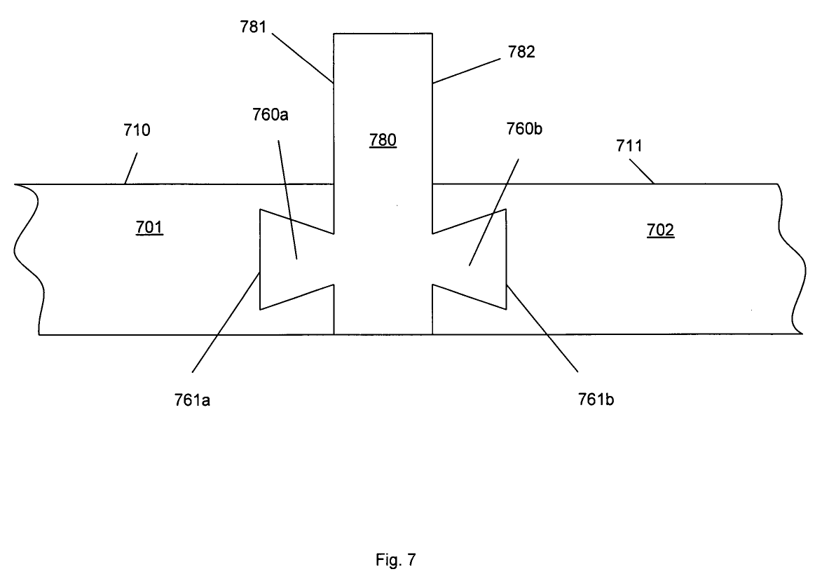

FIG. 7 illustrates a cross-section exemplary embodiment of a sliding dovetail joint configuration of a connector element 780 for joining two adjacent electronic whiteboards. The connector element 780 is adapted to join a first electronic whiteboard 701 to a second electronic whiteboard 702. The first electronic whiteboard 701 can have a first writing surface 710 and the second electronic whiteboard 702 can have a second writing surface 711.

The connector element 780 can comprise a first dovetail 760a and a second dovetail 760b. The dovetails 760a and 760b can be disposed on opposite sides of the connector element 780. The first electronic whiteboard 701 can comprise a first dovetail receiver 761a and the second electronic whiteboard 702 can comprise a second dovetail receiver 761b. The first dovetail 760a can be adapted to slide lengthwise into the first dovetail receiver 761a along the length of the first electronic whiteboard 701. Similarly, the second dovetail 760b can be adapted to slide lengthwise into the second dovetail receiver 761b along the length of the second electronic whiteboard 702. The first and second electronic whiteboards 701 and 702 can be connected by sliding the first and second dovetail 760a and 760b into the first and second dovetail receivers 761a and 761b.

Upon connecting the first and second electronic whiteboards 701 and 702, a portion of the connector element 780 can extend from the first and second writing surfaces 710 and 711. The portion of the connector element 780 extending above the writing surfaces 710 and 711 preferably comprises a first retroreflective surface 781 and a second retroreflective surface 782. The first retroreflective surface 781 can be proximate and normal to the first writing surface. Similarly, the second retroreflective surface 782 can be proximate and normal to the second writing surface 711. The first and second retroreflective surfaces 781 and 782 can reflect light beams from optical detection elements in substantially the same manner as described in the embodiments above.

The dovetails 760a and 760b can be friction fitted into the dovetail receivers 761a and 761b. In other embodiments, the dovetails 760a and 760b can be secured within the dovetails receivers 761a and 761b using a suitable fastener or adhesive to prevent the connector element 880 from sliding downwardly and disengaging from the whiteboards 701 and 702 when the whiteboards 701 and 702 are mounted vertically on a surface. The dovetails 760a and 760b could also snap together or be coupled by another suitable means.

In other contemplated embodiments the dovetails 760a and 760b can be replaced with another suitable shape and the dovetail receivers 761a and 761b can also be replaced with complementary shaped receptacles.

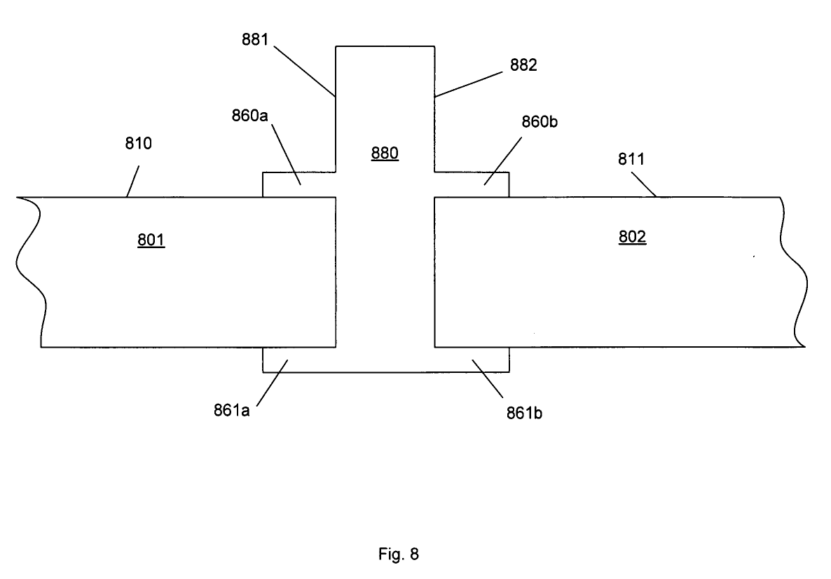

FIG. 8 illustrates a cross-section of an exemplary embodiment of an “I-beam” joint configuration of a connector element 880 for joining two adjacent electronic whiteboards. The connector element 880 is adapted to join a first electronic whiteboard 801 to a second electronic whiteboard 802. The first electronic whiteboard 801 can have a first writing surface 810 and the second electronic whiteboard 802 can have a second writing surface 811.

The connector element 880 can comprise a first upper engagement leg 860a and a second upper engagement leg 860b. The upper engagement legs 860a and 860b can extend from the connector element 880 and come in contact with the first and second writing surface when the first and second whiteboard 801 and 802 are being connected. The connector element 880 can further comprise a first lower engagement leg 861a and a second lower engagement leg 861b. The lower engagement legs 861a and 861b can extend from the connector element 880 and come in contact with the back surfaces of the first and second whiteboards 801 and 802 when the whiteboards 801 and 802 are being connected.

The body of the connector element 880 and the engagement legs 860a, 860b, 861a, and 861b form an “I-beam” having two u-shaped channels on each side. The edges of the first and second electronic whiteboards 801 and 802 can be inserted into the channels to join the whiteboards. The whiteboards 801 and 802 can be friction fitted into the channels of the connector element 880. In other embodiments, a suitable fastener or adhesive substance can be used to secure the whiteboards 801 and 802 within the channels of the connector element 880.

When the whiteboards 801 and 802 are coupled together with the connector element 880, a portion of the connector element 880 extends above the “I-beam” and the writing surfaces. The portion of the connector element 880 extending above the writing surfaces 810 and 811 preferable comprises a first retroreflective surface 881 and a second retroreflective surface 882. The first retroreflective surface 881 can be proximate and normal to the first writing surface. Similarly, the second retroreflective surface 882 can be proximate and normal to the second writing surface 811. The first and second retroreflective surfaces 881 and 882 can reflect light beams from optical detection elements in substantially the same manner as described in the embodiments above.

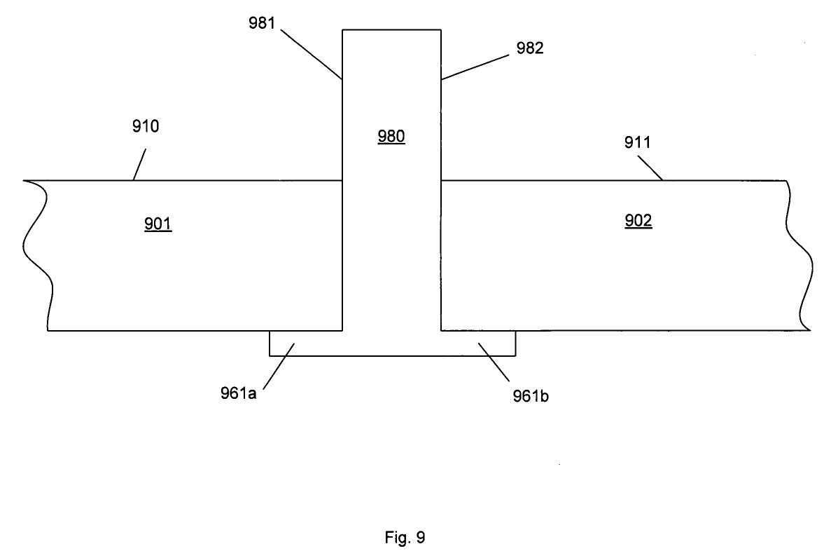

FIG. 9 illustrates cross-section of an exemplary embodiment of a “T-shape” connector element 980. The connector element 980 is adapted to join a first electronic whiteboard 901 to a second electronic whiteboard 902. The first electronic whiteboard 901 can have a first writing surface 910 and the second electronic whiteboard 902 can have a second writing surface 911.

The connector element 980 can comprise a first engagement leg 960a and a second engagement leg 960b, forming a “T-shape”. The engagement legs 960a and 960b can extend from the connector element 980 and come in contact with the back surfaces of the first and second whiteboards 801 and 802 when the whiteboards 801 and 802 are being connected. The connector 980 can be secured to the whiteboard 901 and 902 with a suitable fastener, adhesive, or other attachment means.

When the whiteboards 901 and 902 are coupled together with the connector element 980, a portion (the base of the “T”) of the connector element 980 extends above the writing surfaces 910 and 911. The portion of the connector element 980 extending above the writing surfaces 910 and 911 preferably comprises a first retroreflective surface 981 and a second retroreflective surface 982. The first retroreflective surface 981 can be proximate and normal to the first writing surface. Similarly, the second retroreflective surface 982 can be proximate and normal to the second writing surface 911. The first and second retroreflective surfaces 981 and 982 can reflect light beams from optical detection elements in substantially the same manner as described in the embodiments above.

In another contemplated embodiment, the engagement legs 960a and 960b can be omitted from the connector 980. In such an embodiment, the connector 980 would have a simple rectangular or square cross-section. In this embodiments, the connector 980 could be inserted into and secured in a gap between the whiteboards 901 and 902.

While the various embodiments of this invention have been described in detail with particular reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all applicable equivalents.

What is claimed is:

1. An electronic whiteboard system comprising:
a writing surface;
a first optical detection element coupled to the writing surface;
a second optical detection element coupled to the writing surface; and
a divider element disposed proximate the writing surface between the first and second optical detectors.

2. The system of claim 1, the divider element comprising a first retroreflective surface and a second retroreflective surface.

3. The system of claim 2, the first retroreflective surface adapted to reflect a light beam emitted from the first optical detection element back to first optical detection element and the second retroreflective surface adapted to reflect a light beam emitted from the second optical detection element back to the second optical detection element.

4. The system of claim 1, the divider element dividing the writing surface into a first area and a second area.

5. The system of claim 4, the first optical detection element and a third optical detection element adapted to detect an object in contact with or in proximity to the first area and the second optical detection element and a fourth optical detection element adapted to detect an object in contact with or in proximity to the second area.

6. The system of claim 1, further comprising a retroreflective perimeter surrounding at least three edges of the writing surface for reflecting light beams emitted from the optical detection elements along a parallel and path.

7. The system of claim 1, the optical detection elements each comprising an optical emitter and an optical receiver.

8. An electronic whiteboard assembly, comprising:
a first writing surface having a first side, a second side, a third side, and a fourth side;
a second writing surface having a first side, a second side, a third side, and a fourth side;
a first perimeter disposed along the first, second, and third sides of the first writing surface;
a second perimeter disposed along the first, second, and third sides of the of the second writing surface; and
a connector element engaging the fourth side of the first writing surface and the fourth side of the second writing surface to connect the first and second writing surfaces.

9. The assembly of claim 8, further comprising:
first, second, third, and fourth optical detection units, each optical detection unit having a light emitting element and a light detecting element, the first and second optical detection units coupled proximate separate corners of the first writing surface, and the third and fourth optical detection units coupled proximate separate corners of the second writing surface.

10. The assembly of claim 9, the first perimeter having a retroreflective surface normal to the first writing surface, the second perimeter having a retroreflective surface normal to the second writing surface, the connector element having a first retroreflective surface and a second retroreflective surface, the retroreflective surface of the of the first perimeter adapted to reflect light beams from the light emitting elements of the first and second optical detection units back along a parallel path to the light detecting elements of the first and second optical detection elements, the first retroreflective surface of the connector element adapted to reflect light beams emitted from the light emitting element of the second optical detection unit back along a parallel path to the light detecting element of the first optical detecting element.

11. The assembly of claim 8, the first and second optical detection units having overlapping fields of view extending substantially across the entire first writing surface, the third and fourth optical detection units having overlapping fields of view extending substantially across the entire second writing surface.

12. The assembly of claim 8, the connector element being equal in length to the fourth sides of the first and second writing surfaces.

13. The assembly of claim 8, the connector element having a first retroreflective surface normal to the first writing surface and a second retroreflective surface normal to the second writing surface.

14. The assembly of claim 8, the connector releaseably engaging the fourth sides of the first and second writing surfaces.

15. An electronic whiteboard connector for coupling a first and a second electronic whiteboard, the connector comprising:
a body adapted to be disposed between the edges of the first and second whiteboards;
a first engagement portion for engaging an edge of the first electronic whiteboard;
a second engagement portion for engaging an edge of the second electronic whiteboard; and
a reflective portion extending above the surface of the electronic whiteboards.

16. The connector of claim 15, wherein the reflective portion comprises a first retroreflective surface normal and proximate the surface of the first whiteboard and a second retroreflective surface normal and proximate the surface of the second whiteboard.

17. The connector of claim 15, wherein the first engagement portion is a first dovetail adapted to be inserted into a dovetail receiver of the first electronic whiteboard and the second engagement portion is a second dovetail adapted to be inserted into a dovetail receiver of the second electronic whiteboard.

18. The connector of claim 16, wherein the first engagement portion is a first channel for receiving an edge of the first electronic whiteboard and the second engagement portion is second channel for receiving an edge of the second electronic whiteboard.

19. The connector of claim 16, the first and second engagement portions frictionally securing the first and second whiteboards to the connector.
